(19) United States
(12) Patent Application Publication
(10) Pub. No.: US 2007/0048502 A1
(43) Pub. Date: Mar. 1, 2007

(54) Structural sandwich plate members with forms

(76) Inventor: Stephen John Kennedy, Ontario (CA)

Correspondence Address: NIXON & VANDERHYE, PC, 901 NORTH GLEBE ROAD, 11TH FLOOR, ARLINGTON, VA, 22203, US

(21) Appl. No.: 10/578,843

(22) PCT Filed: Nov. 1, 2004
(86) PCT No.: PCT/GB04/04622

§ 371 Date: Sep. 8, 2006

(30) Foreign Application Priority Data
Nov. 14, 2003 (GB) 0326608.7

(51) Int. Cl. B32B 3/12

(52) U.S. Cl. 428/178

(57) ABSTRACT

A structural sandwich plate member is provided with a plurality of lightweight forms within the space between the outers plates. The forms do not tesselate and have principal dimensions in the range of from 20 to 200% of the distance between the outer plates.

The present invention relates to structural sandwich plate members which comprise two outer plates and a core of plastics or polymer material bonded to the outer plates with sufficient strength to substantially contribute to the structural strength of the member.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems may be used in many forms of construction to replace stiffened steel plates or formed steel plates and greatly simplify the resultant structures, improving strength and structural performance (e.g. stiffness, damping characteristics) while saving weight. Further developments of these structural sandwich plate members are described in WO 01/32414, also incorporated hereby by reference. As described therein, foam forms may be incorporated in the core layer to reduce weight and transverse metal sheer plates may be added to improve stiffness.

According to the teachings of WO 01/32414 the foam forms can be either hollow or solid. Hollow forms generate a greater weight reduction and are therefore advantageous. The forms described in that document are not confined to being made of light weight foam material and can also be make of other materials such as wood or steel boxes.

International Patent Application WO 02/078948 is a further development of the concept of including hollow forms and describes forms that are easy to manufacture and assemble, in particular hollow elongate forms made from snap-together pieces are described. GB 2 374 038 A, priority from which is claimed in WO 02/078948, suggests the use of spherical members but without giving any practical details, e.g. sizes or materials for the spheres.

In WO 01/32414 and WO 02/078948 the elongate forms are sized according to the plate member being made. Thus, the techniques disclosed in these two documents are most applicable where a large number of identical plate members are to be made so that the forms can be economically mass-produced, e.g. by moulding. If a small number of plates of a given size or shape are to be made, the forms will need to be handmade or adapted at relatively great expense.

It is an aim of the present invention to provide structural sandwich plate members with forms or inserts that can be readily adapted to different sizes and/or shapes of plate.

According to the present invention, there is provided a structural sandwich plate member comprising: first and second outer plates; a core of plastics or polymer material bonded to said outer plates with sufficient strength to transfer shear forces therebetween; and a plurality of lightweight forms within the core, wherein said forms do not tesselate in a plane parallel to said outer metal layers and have principal dimensions in the range of from 20 to 200% of the distance between said outer metal layers.

The term “principal dimensions” is intended to refer to the diameter of a sphere, the major and minor diameters of an ovoid, the length, depth and breadth of a cuboid, etc. In the case of irregular shapes, the principal dimensions may be regarded as the dimensions of the smallest rectangular box in which the shape will fit.

By using forms that are comparable in dimensions to the gap between the metal layers, and hence relatively small compared to the lateral dimension (length and/or width) of the plate member, any shape of plate can be manufactured using standard mass-produced forms, without the need for hand adaptation. The exact shape of the form is not crucial in many cases, though additional advantages can be obtained with specific shapes. It is required that the forms do not tesselate so that there are spaces between them for the core material which bonds to the outer plates. The shape and arrangement of the forms can be varied to vary the proportion of the volume between the outer plates that is occupied by core material.

The forms may be arranged in a single layer or multiple layers. In the case of multiple layers, it is preferred in some applications that the forms of one layer directly overly the forms of the layer below so that there are parts of the core material extending perpendicularly between the outer metal layers. Where there are multiple layers of forms, an interlayer may be provided between the layers of forms. The layer may be made of a high tensile strength material such as metal, a high tensile strength fabric, such as Kevlar™ or Spectra™, fibre reinforced plastic, other suitable fabrics, mesh or ceramic sheets to improve the blast and/or ballistic resistance of the plate member. The layer may be perforated or shaped to allow flow of core material throughout the core during fabrication and to enhance the shear strength between the layers. The layer may also be used to assist the placing of the forms—e.g. to determine the spacing between layers or the relative positions of the forms in different layers—and thereby enhance the performance of the plate member.

A particularly preferred form is a spherical hollow ball having a diameter substantially equal to 1/N of the distance between said outer metal layers, N being a natural number between 1 and 5. The balls may for example have a diameter in the range of from 20 to 100 mm and can be used in single or multiple layers in plate members with core thicknesses in the range of from 20 to 100 mm. Balls made of polypropylene are particularly suitable and may be solid or preferably hollow with a solid skin. Solid balls provide less weight reduction but may still be advantageous as they are cheaper than the elastomers preferred as the core material. Such balls are widely available and cheap to manufacture.

The forms may also be provided with a plurality of protrusions so as to increase the spacing between the forms, and hence the proportion of the core cavity occupied by core material. The protrusions may also be arranged to determine the relative shapes and positions adopted by adjacent forms and hence the shape of the void space that is filled by core material, e.g. to ensure a continuous mass of core material.

A mesh, e.g of wire, may be used to assist the placing of the forms and space them apart from each other and/or from the metal layers.

The materials, dimensions and general properties of the outer plates of the structural sandwich plate member of the invention may be chosen as desired for the particular use to which the structural sandwich plate member is to be put and in general may be as described in U.S. Pat. No. 5,778,813 and U.S. Pat. No. 6,050,208. Steel or stainless steel is commonly used in thicknesses of 0.5 to 20 mm and aluminium may be used where light weight is desirable. Aluminium in general may be used in thicknesses 2 to 4 times that of steel, i.e. 1 to 50 mm, to give comparable strength. Similarly, the plastics or polymer core may be any suitable material, for example an elastomer such as polyurethane, as described in U.S. Pat. No. 5,778,813 and U.S. Pat. No. 6,050,208.

Further, the invention provides a method of manufacturing a structural sandwich plate member comprising the steps of:

providing first and second outer plates in a spaced-apart relationship and a plurality of lightweight forms within the space between said plates, wherein said forms do not tesselate in a plane parallel to said outer metal layers and have principal dimensions in the range of from 20 to 200% of the distance between said plates;

injecting uncured plastics or polymer material to fill the space defined between said outer plates and around said plurality of forms; and

allowing said plastics or polymer material to cure to bond said outer plates together with sufficient strength to transfer shear forces therebetween.

The present invention will be described below with reference to exemplary embodiments and the accompanying schematic drawings, in which:

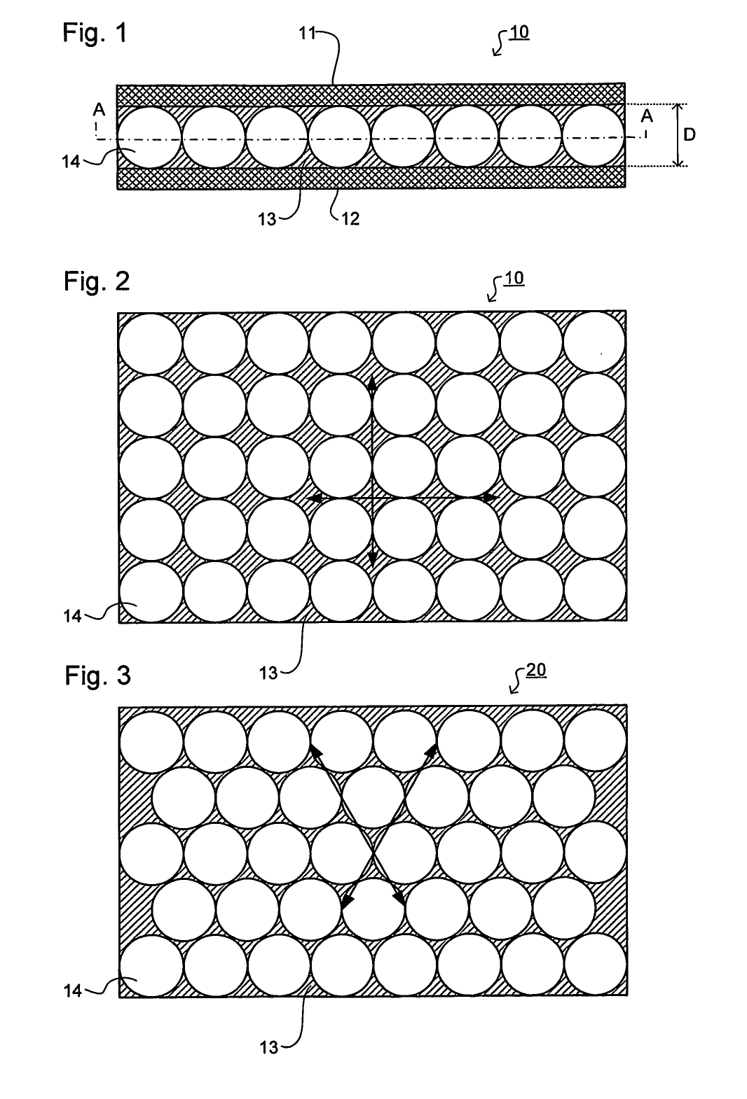

FIG. 1 is a cross-sectional view of a structural sandwich plate member according to a first embodiment of the present invention;

FIG. 2 is a cross-sectional view of the structural sandwich plate member of FIG. 1 along the line A-A;

FIG. 3 is a cross-sectional view similar to FIG. 2 of a structural sandwich plate member according to a variant of the first embodiment of the present invention;

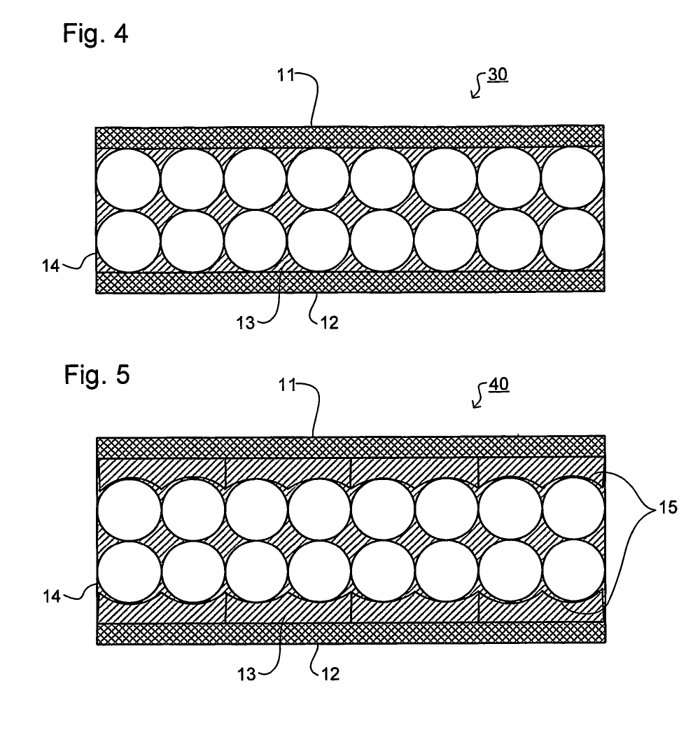

FIG. 4 is a cross-sectional view of a structural sandwich plate member according to a second embodiment of the present invention;

FIG. 5 is a cross-sectional view of a structural sandwich plate member according to a third embodiment of the present invention;

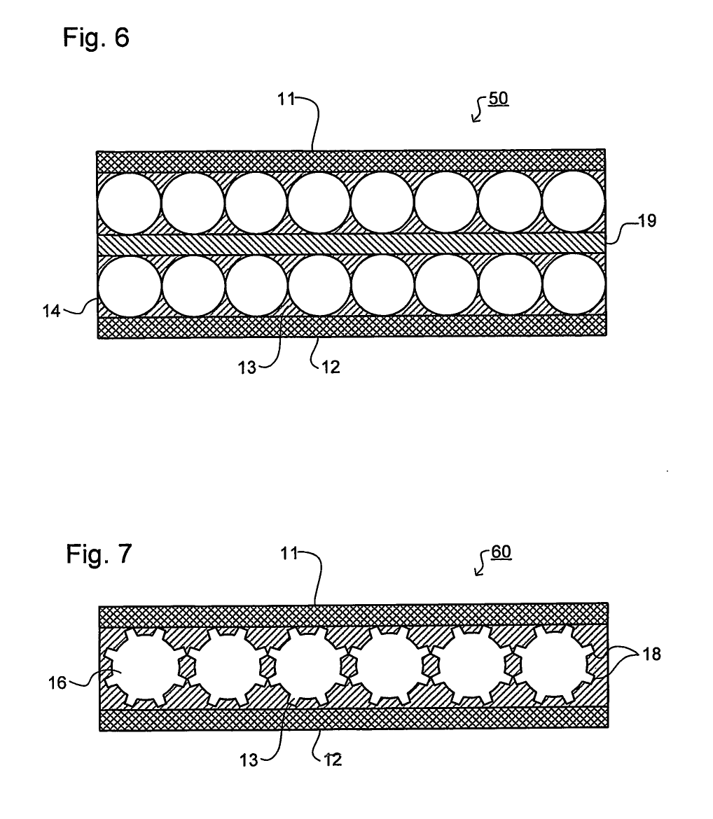

FIG. 6 is a cross-sectional view of a structural sandwich plate member according to a fourth embodiment of the present invention; and

FIG. 7 is a cross-sectional view of a structural sandwich plate member according to a fifth embodiment of the present invention;

In the various drawings, like parts are indicated by like reference numerals.

The structural sandwich plate member shown in FIG. 1 comprises upper and lower outer plates (face plates) 11, 12 which may be of steel (e.g. of thickness in the range of from 0.5 to 20 mm) or aluminium (e.g. of thickness in the range of 1 to 50 mm). Edge plates (not shown) are welded between the face plates 11, 12 around their outer peripheries to form a closed cavity. Alternatively, the plate member may be assembled in a mould, obviating the need for edge plates. In the cavity between the face plates 11, 12 is a core 13 of plastics or polymer material, preferably a thermosetting material such as polyurethane elastomer. This core may have a thickness in the range of from 15 to 200 mm; in the present application 50 mm is suitable. The core 13 is bonded to the face plates 11, 12 with sufficient strength and has sufficient mechanical properties to transfer shear forces expected in use between the two face plates. It is preferably compact. The bond strength between the core 13 and face plates 11, 12 should be greater than 3 MPa, preferably 6 MPa, and the modulus of elasticity of the core material should be greater than 200 MPa, preferably 250 MPa. A lower modulus may be used where high temperature conditions will not be experienced. For low load applications, such as floor panels, where the typical use and occupancy loads are of the order of 1.4 kPa to 7.2 kPa, the bond strength may be lower, e.g. approximately 1 MPa. By virtue of the core layer, the structural sandwich plate member has a strength and load bearing capacity of a stiffened steel plate having a substantially greater plate thickness and significant additional stiffening. The plate, of course, need not be flat but may take any form required for its intended use.

To reduce the weight of the plate member, a plurality of lightweight forms 14 are provided in the core. In this embodiment, the forms 14 comprise hollow, solid skin polypropylene balls having a diameter substantially equal to the distance D between the outer plates 11, 12. As shown in FIG. 2, which is a cross-section along the line A-A in FIG. 1, the balls 14 are arranged in orthogonal rows and columns so that substantial gaps are left between them. This arrangement of forms is particularly appropriate where the major loads in use are directed along the lateral and longitudinal directions, indicated by arrows in FIG. 2. These gaps fill with core material which bonds the outer metal plates together. Because of the curvature of the balls, the core material forms column-like structures extending directly between the outer plates and bonded to the plates over a wide area. Thus the bond strength compared to a solid core is reduced by no more than about 5% and the shear transfer capability is maintained.

The balls 14 may also be closely packed in a hexagonal array, as shown in FIG. 3. This results in a lighter plate member 20 as the proportion of the core cavity that is occupied by the core material 133 is reduced. The plate member is also particularly suited to applications in which the major loads will lie on oblique directions, as indicated by arrows in FIG. 3.

To manufacture the structural sandwich plate member 10, the edge plates are welded around the periphery of lower faceplate 12 and then the balls 14 are placed in the resulting open cavity. At this stage, any precast sections of the core may be put in place as well as any shear plates or other fittings that may be desired. Then, the upper faceplate 11 is welded to the edge plates to form a closed cavity and the plastics or polymer material injected to form core 13. The injected material is then allowed to cure and the injection ports used in the injection step ground off and sealed along with the vent holes. These steps may be performed in situ, or off-site in factory conditions and the finished panel transported to the installation site. Prior to the injection of the core, the balls 13 help to support the upper faceplate 11 so that larger plate members may be manufactured without sagging and without the need for internal supports.

A second embodiment of the present invention is shown in FIG. 4. The structural sandwich plate member 30 according to the second embodiment of the invention is similar to the first embodiment but includes two layers of balls 14. This enables a thicker plate member to be made without increasing the spacing of the column-like structures of the core. Preferably, as shown, the balls of one layer overly the balls of the other layer but in lower load applications the balls may be close packed in the vertical direction as well as in the horizontal direction. Of course three or more layers of forms may be provided and the different layers of forms need not all be the same, however it is preferred that there are 5 or fewer layers.

FIG. 5 illustrates a third embodiment of the present invention. This includes a mesh 15 above and below the layers of balls to space them away from the outer metal plates to increase the bond area between core and the plates. The presence of a solid layer of core material adjacent the metal plates 11,12 also improves curing and ensures a more uniform impact resistance across the area of the plate member. The mesh may be a simple wire mesh that is moulded by hand to the desired shape. Mesh may also be provided between layers of balls and may serve to assist placement of the balls and to space them apart from each other.

A fourth embodiment of the invention is shown in FIG. 6. In addition to the two layers of forms 14, as provided in the second embodiment, the plate member 50 of the fourth embodiment includes an interlayer 19 provided between the layers of forms. The interlayer 19 may take a variety of forms for a variety of different purposes. For improved blast and/or ballistics protection, the interlayer 19 may be made of a high tensile strength material such as metal, a high tensile strength fabric, such as Kevlar™ or Spectra™, fibre reinforced plastic, other suitable fabrics, mesh or ceramic sheets. Suitable materials and forms of the interlayer for this purpose are described in copending British patent application number 0326609.5 (Agent's ref N. 88882) entitled “IMPROVED STRUCTURAL SANDWICH PLATE MEMBERS” and filed on 14 Nov. 2003. The whole contents of this document are incorporated by reference. The interlayer may also be shaped so as to assist or determine the placing of the forms—e.g. their spacing, orientation or the relative positions of the different layers—and if that is the sole purpose of the interlayer it may be made of the same material as the core or a cheaper material, especially if a mesh.

An alternative approach to increasing the spacing between the balls, is to provide them with projections, as shown in FIG. 7. This shows plate member 60 according to a fifth embodiment of the invention, which is generally the same as the first embodiment, save that the balls 16 are provided with a plurality of projections 18 around their surfaces. The projections 18 serve to increase the ball to ball spacing as well as the ball to metal plate spacing, increasing the bond strength of the core to the metal plates and the shear transfer capacity.

Depending on the intended use of the plate member, various of its properties may be enhanced by the use of different materials for the lightweight forms 14, 16 and by the provision of different fillings for the forms. For example, the forms 14, 16 may be made of metal, ceramic, Kevlar or other high-strength materials to increase the blast and ballistic resistance of the plate member and also to improve shrapnel capture and fragmentation resistance. This may provide particular advantages if an interlayer as described above is also provided for increased blast and ballistics resistance. To increase fire resistance, the forms may also be made of metal or ceramic and may be filled with inert or fire-retardant materials. Other gas or liquid fillings may also be used to improve the acoustic and/or thermal insulation properties of the metal plate. The forms may for the same reason be evacuated.

It will be appreciated that the above description is not intended to be limiting and that other modifications and variations fall within the scope of the present invention, which is defined by the appended claims. For example, whilst in the described embodiments all the forms are the same, it will be appreciated that mixtures of different shapes and/or sizes of form may also be used.

1. A structural sandwich plate member comprising:
first and second outer plates;
a core of plastics or polymer material bonded to said outer plates with sufficient strength to transfer shear forces therebetween; and
a plurality of lightweight forms within the core, wherein said forms do not tesselate in a plane parallel to said outer metal layers and have principal dimensions in the range of from 20 to 200% of the distance between said outer metal layers.

2. A structural sandwich plate member according to claim 1 wherein said lightweight forms are arranged in a single layer.

3. A structural sandwich plate member according to claim 1 wherein said lightweight forms are arranged in multiple layers.

4. A structural sandwich plate member according to claim 3 further comprising an interlayer between two of said multiple layers of forms.

5. A structural sandwich plate member according to claim 3 or 4 wherein the forms of one layer directly overly the forms of the layer below so that there are parts of the core material extending directly between the outer plates.

6. A structural sandwich plate member according to any one of the preceding claims wherein said lightweight forms are hollow.

7. A structural sandwich plate member according to any one of the preceding claims wherein said forms are spherical.

8. A structural sandwich plate member according to claim 7 wherein said forms have a diameter substantially equal to 1/N of the distance between said outer plates, N being an integer in the range of from 1 to 5.

9. A structural sandwich plate member according any one of the preceding claims wherein said forms have a diameter greater than or equal to 20 mm.

10. A structural sandwich plate member according any one of the preceding claims wherein said forms have a diameter less than or equal to 100 mm.

11. A structural sandwich plate member according to claim 6, 7, 8, 9 or 10 wherein said forms are made of polypropylene and have a solid skin.

12. A structural sandwich plate member according to any one of claims 1 to 10 wherein said forms are made of metal ceramic, or a high tensile strength fabric, such as Kevlar™ or Spectra™.

13. A structural sandwich plate member according to any one of the preceding claims wherein said forms have a plurality of protrusions so as to increase the spacing between them, and hence the proportion of the core cavity occupied by core material.

14. A structural sandwich plate member according to any one of the preceding claims wherein said forms are filled with an inert gas, a fire retardant substance, a thermal or acoustic insulating fluid or a partial vacuum.

15. A structural sandwich plate member according to any one of the preceding claims further comprising a mesh, e.g of wire, to assist the placing of the forms and space them apart from each other and/or from the outer plates.

16. A structural sandwich plate member according to any one of the preceding claims wherein said core has a thickness greater than or equal to 20 mm.

17. A structural sandwich plate member according to any one of the preceding claims wherein said outer plates are made of metal.

18. A structural sandwich plate member according to any one of the preceding claims wherein said outer plates have a thickness greater than or equal to 0.5 mm.

19. A method of manufacturing a structural sandwich plate member comprising the steps of:
providing first and second outer plates in a spaced-apart relationship and a plurality of lightweight forms within the space between said plates, wherein said forms do not tesselate in a plane parallel to said outer metal layers and have principal dimensions in the range of from 20 to 200% of the distance between said plates;
injecting uncured plastics or polymer material to fill the space defined between said outer plates and around said plurality of forms; and
allowing said plastics or polymer material to cure to bond said outer plates together with sufficient strength to transfer shear forces therebetween.
